(19) United States
(12) Patent Application Publication
(10) Pub. No.: US 2025/0145844 A1
(43) Pub. Date: May 8, 2025

(54) THIOL-BASED SMALL MOLECULE BINDERS FOR IMPROVING THE METAL-SILICONE INTERFACE FOR STRETCHABLE ELECTRONICS

(71) Applicant: Meta Platforms Technologies, LLC, Menlo Park, CA (US)

(72) Inventors: Wenyang Pan, Redmond, WA (US); Kristopher Erickson, Sammamish, WA (US); Zixuan Deng, Redmond, WA (US); Zhenzhen Shen, Kirkland, WA (US); Cameron Glasscock, Redmond, WA (US)

(21) Appl. No.: 18/934,489

(22) Filed: Nov. 1, 2024

Related U.S. Application Data
(60) Provisional application No. 63/596,080, filed on Nov. 3, 2023.

(51) Int. Cl. C09D 11/102; C08K 3/105; C09D 11/033

(52) U.S. Cl. CPC C09D 11/102; C09D 11/033; C08K 3/105; C08K 2201/001; C08K 2201/011

(57) ABSTRACT

Described herein are compositions and methods for wetting and adhering noble metal inks to silicone substrates. The metal ink-silicone interface is modified by functionalizing the surface of noble metal nanoparticles (NPs) or nanowires (NWs), and/or the surface of silicone substrates, with a small molecule binder for thiol-noble metal bonding.

### CROSS-REFERENCES TO RELATED APPLICATION

This application claims priority to U.S. Provisional Application No. 63/596,080, filed on Nov. 3, 2023, which is incorporated herein by reference in its entirety.

### BACKGROUND

Silicone or polydimethylsiloxane (PDMS) materials are used in wearable devices, owing to their low cost, wide availability, softness, and biocompatibility. However, using PDMS/silicone as polymer substrates for stretchable and flexible electronics is challenging. Some issues in particular that are encountered with using these materials as substrates for such electronics include poor wetting and adhesion between the deposited electronically conductive metal traces/interconnects, and a very inert/hydrophobic silicone surface.

### SUMMARY

Described herein are compositions and methods for wetting and adhering noble metal inks to silicone substrates. As described herein, the metal ink-silicone interface is modified by functionalizing the surface of noble metal nanoparticles (NPs) or nanowires (NWs), such as silver (Ag) NPs or NWs, and/or the surface of silicone substrates, using small molecule binders for thiol-noble metal bonding.

Also described herein is a composition comprising a small molecule binder comprising a thiol group and a sulfonic acid group, a silicon-based organic polymer, and a plurality of nanoparticles or nanowires comprising at least one of Ru, Rh, Pd, Ag, Os, Ir, Pt, or Au, and methods of making and using the same. In some examples, the small molecule binder may include 3-mercapto-1-propanesulfonic acid, 2-mercapto-ethanesulfonic acid, 3-(5-mercapto-1-tetrazolyl)benzenesulfonic acid, or a combination thereof. Optionally, the silicon-based organic polymer may be terminated with an amine. In some examples, the amine is a primary amine or a secondary amine. In some examples, the silicon-based organic polymer has an M_{w} from about 700 to about 3000 Da. In some examples, the silicon-based organic polymer is polydimethylsiloxane (PDMS).

Further described herein is a composition comprising a small molecule binder comprising a thiol group and a silane group, a silicon-based organic polymer, and a plurality of nanoparticles or nanowires comprising at least one of Ru, Rh, Pd, Ag, Os, Ir, Pt, or Au, and methods of making and using the same. In some examples, the small molecule binder may include 3-mercapto-1-propanesulfonic acid, 2-mercapto-ethanesulfonic acid, 3-(5-mercapto-1-tetrazolyl)benzenesulfonic acid, mercapto propyl trihydroxy silane, or a combination thereof. Optionally, the silicon-based organic polymer may be terminated with an amine. In some examples, the amine is a primary amine or a secondary amine. In some examples, the silicon-based organic polymer has an M_{w} from about 700 to about 3000 Da. In some examples, the silicon-based organic polymer is polydimethylsiloxane (PDMS).

The details of one or more embodiments are set forth in the drawings and the description below. Other features, objects, and advantages will be apparent from the description and drawings, and from the claims.

### BRIEF DESCRIPTION OF THE DRAWINGS

FIG. 1 shows a non-limiting example of protonated sodium 3-mercapto-1-propanesulfonate (MPS) binding to amine-terminated PDMS.

FIG. 2, left panel, shows a non-limiting example of the wetting properties of a composition described herein on an ELASTOSIL silicone substrate. FIG. 2, right panel, shows the wetting properties of a control composition on an ELASTOSIL silicone substrate that does not include the small molecule binder including a thiol and a sulfonic acid as described herein. Both samples shown in the left and right panels were stretched to 20% strain for 100 cycles.

FIG. 3, left panel, shows a non-limiting example of the wetting properties of a composition described herein on a SYLGARD 184 silicone substrate, and the inset of the left panel shows a magnified view of the first sixty cycles of the data in the main graph. FIG. 3, right panel, shows the wetting properties of a control composition on a SYLGARD 184 silicone substrate that does not include a small molecule binder comprising a thiol and a sulfonic acid as described herein. Both samples shown in the left and right panels were stretched to 20% strain for 100 cycles.

FIG. 4 shows microscopic images of ELASTOSIL silicone substrates printed with compositions as described herein (left) and control compositions that lack the small molecule binders including a thiol and a sulfonic acid (right). The wider trace shown on the left indicates improved wetting properties of the compositions described herein compared to the control composition on the right.

FIG. 5 shows microscopic images of SYLGARD 184 silicone substrates printed with compositions as described herein (left) and control compositions that lack the small molecule binders comprising a thiol and a sulfonic acid (right). The wider trace shown on the left indicates improved wetting properties of the compositions described herein compared to the control composition on the right.

FIG. 6 shows a nonlimiting example of the adhesion properties after a tape peel test of compositions described herein to silicone substrates.

FIGS. 7A and 7B show two nonlimiting examples of methods for preparing compositions as described herein for wetting to silicone substrates.

FIG. 8 shows a nonlimiting schematic example of a composition as described herein for adhering noble metal inks to silicone substrates.

### DETAILED DESCRIPTION

Described herein are compositions and methods directed to wetting and/or adhering noble metal inks to silicone substrates. In some examples, the noble metal inks include silver (Ag).

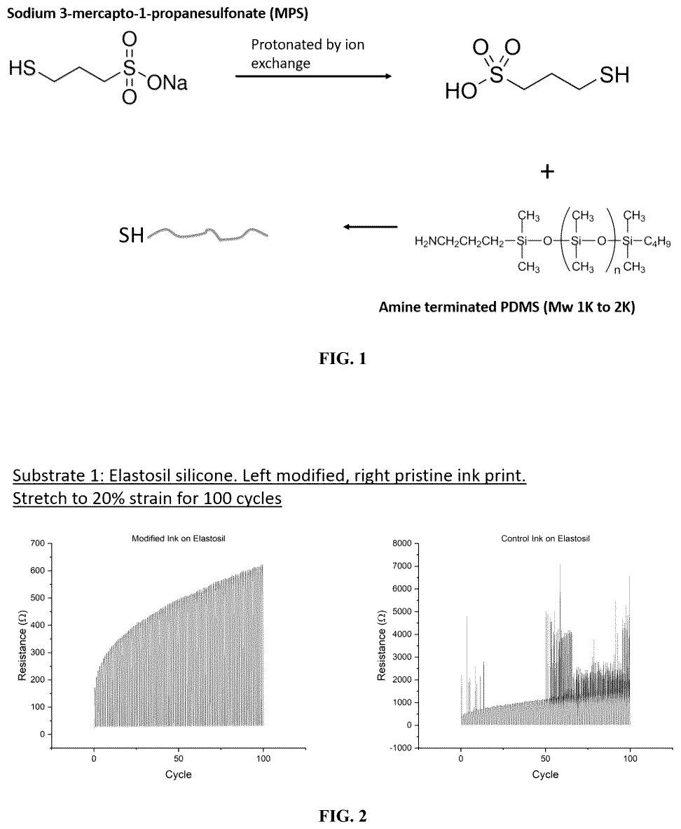

Without being limited by theory, the compositions and methods described herein utilize strong bonding between a thiol group (—SH) of small molecule binders described herein and noble metals, such as, but not limited to, silver (Ag) or gold (Au). Without being limited by theory, this thiol-metal bond, such as the thiol-Ag bond, is much stronger (1-2 orders of magnitude) than the hydrogen bonding or van der Waals forces and can be used to graft short silicon-based organic polymers, such as polydimethylsiloxane (PDMS), to silver for wetting. The grafting of the PDMS to Ag is through a small molecule binder, in some examples 3-mercapto-1-propanesulfonic acid, on which one end is a thiol group (—SH) for bonding to Ag and on the other end is a sulfonic acid (—SO₃H) group to bind to an amine-terminated PDMS, as shown in FIG. 1.

In some examples, sodium 3-mercapto-1-propanesulfonate (MPS) is protonated to form one example of the small molecule binder, 3-mercapto-1-propanesulfonic acid, wherein the protonation step can be carried out in water and/or an organic solvent, depending on compatibility with a desired noble metal ink. To a solution of the noble metal ink, trace amounts of the small molecule binder can be added, followed by an amine-terminated silicon-based polymer, to produce a noble metal ink modified with the small molecule binder and amine-terminated silicon-based polymer. In some examples, the modified noble metal inks described herein may exhibit improved wetting on silicone substrates compared to unmodified noble metal inks. In some examples, the modified noble metal inks may be further modified with a small molecule binder including a thiol and a silane, wherein, without being limited by theory, the silane can promote increased adhesion of the noble metal ink to the silicone substrate.

### 1. Compositions for Wetting of Noble Metal Inks to Silicone Substrates

Described herein is a composition for wetting noble metal inks to silicone substrates. The compositions include a small molecule binder including a thiol group and a sulfonic acid group, a silicon-based organic polymer, and a plurality of nanoparticles or nanowires comprising at least one of Ru, Rh, Pd, Ag, Os, Ir, Pt, or Au.

The small molecule binder including a thiol group and a sulfonic acid group refers to an organic compound that includes one or more thiol groups and one or more sulfonic acid groups. In some examples, the small molecule binder including a thiol group and a sulfonic acid group can be selected from 3-mercapto-1-propanesulfonic acid, 2-mercapto-ethanesulfonic acid, 3-(5-mercapto-1-tetrazolyl)benzenesulfonic acid, 5-mercaptoquinoline-8-sulfonic acid, 4-mercaptoquinoline-8-sulfonic acid, 8-mercaptoquinoline-5-sulfonic acid, 4-mercaptoquinoline-3-sulfonic acid, 2-mercapto-5-benzimidazolesulfonic acid, or combinations thereof. In some examples, the small molecule binder including a thiol group and a sulfonic acid group can be prepared from a small molecule binder including a thiol group and a sulfonate group, wherein the sulfonate group is protonated with a protonating reagent to form a sulfonic acid group.

In some examples, the silicon-based organic polymer includes a polysiloxane (silicone polymer). In some examples, the silicone polymer is polydimethylsiloxane (PDMS), polymethyl vinyl siloxane, polymethyl hydrogen siloxane, or copolymers or a combination thereof. In some examples, the silicon-based organic polymer is a fluorosilicone. In some examples, the fluorosilicone includes a siloxane backbone and fluorocarbon pendant groups. In some examples, the fluorosilicone is poly (3,3,3-trifluoropropyl methylsiloxane) (PTFPMS). In some examples, the fluorosilicone is SILASTIC (commercially available from Dow, Midland, MI). In some examples, the fluorosilicone is SHIN ETSU FE or SHIN ETSU FEA (commercially available from Shin-Etsu Silicones of America, Inc., Akorn, OH) (e.g., FE-221U, FE-281U, FE-341U, FE-361U, FE-371U, FE-381U, FE-401U, FEA-241U, FEA-251U, FEA-261U, or FEA-271U). In some examples, the silicone-based polymer is a block copolymer containing PDMS and fluorocarbon segments.

In some examples, the silicon-based organic polymer is amine-terminated. In some examples, the PDMS, polymethyl vinyl siloxane, or polymethyl hydrogen siloxane is amine-terminated. In some examples, the amine is a primary amine, a secondary amine, a tertiary amine, or a quaternary amine. In some examples, the amine is optionally substituted with alkyl or aryl groups. As used herein, alkyl refers to straight-and branched-chain monovalent substituents. Ranges of these groups useful with the compounds and methods described herein include C₁-C₂₀ alkyl, C₁-C₁₈ alkyl, C₁-C₁₆ alkyl, C₁-C₁₄ alkyl, C₁-C₁₂ alkyl, C-C₁₀ alkyl, C₁-C₈ alkyl, C₁-C₆ alkyl, and C₁-C₄ alkyl. Examples include methyl, ethyl, propyl, butyl, isobutyl, octyl, and the like. Aryl molecules include, for example, cyclic hydrocarbons that incorporate one or more planar sets of, typically, six carbon atoms that are connected by delocalized electrons numbering the same as if they consisted of alternating single and double covalent bonds. An example of an aryl molecule is benzene (i.e., a phenyl group). In some examples, the amine is —NRR′, wherein R and R′ are independently selected from hydrogen, halogen, hydroxyl, alkyl, haloalkyl, aryl, and heteroaryl. In some examples, the amine is a substituted or unsubstituted cyclic amine, such as a pyrrolidine, where the pyrrolidine may be optionally substituted with alkyl or aryl groups. In some examples, the amine is a protonated ammonium —(NRR′H)⁺, wherein R and R′ are independently selected from hydrogen, halogen, hydroxyl, alkyl, haloalkyl, aryl, and heteroaryl. In some examples, the amine-terminated PDMS is a mono-amino terminated PDMS, including but not limited to, monoaminopropyl terminated polydimethylsiloxane, asymmetric, 18-25 cSt (MCR-A12), or monoaminopropyl terminated polydimethylsiloxane, asymmetric, 8-12 cSt (MCR-A11), commercially available from Gelest, Inc. (Morrisville, Pennsylvania). In some examples, the silicon-based organic polymer is terminated with an imidazole group, where the imidazole group may be optionally substituted with alkyl or aryl groups.

In some examples, the silicon-based organic polymer has an M_{w} (weighted average molecular weight) from 700 Da to 3000 Da (Daltons) (e.g., from 750 Da to 2900 Da, from 800 Da to 2800 Da, from 850 Da to 2700 Da, from 900 Da to 2600 Da, from 950 Da to 2500 Da, from 1000 Da to 2400 Da, from 1100 Da to 2300 Da, from 1200 Da to 2200 Da, from 1300 Da to 2100 Da, from 1400 Da to 2000 Da, from 1500 Da to 1900 Da, or from 1600 Da to 1800 Da). In some examples, the silicon-based organic polymer has an M_{w} from 3000 Da to 100,000 Da (e.g., from 3000 Da to 90,000 Da, from 6000 Da to 80,000 Da, from 12,000 Da to 70,000 Da, from 18,000 Da to 60,000 Da, or from 24,000 Da to 50,000 Da).

In some examples, the plurality of nanoparticles or nanowires includes Ag. In some examples, the plurality of nanoparticles or nanowires includes Au. In some examples, the composition includes nanoparticles comprising Ag and/or Au. In some examples, the composition includes nanowires comprising Ag and/or Au.

In some examples, the plurality of nanoparticles or nanowires includes nanoparticles having a diameter from approximately 10 nm to 1,000 nm (e.g., from 20 nm to 950 nm, from 30 nm to 900 nm, from 40 nm to 850 nm, from 50 nm to 800 nm, from 60 nm to 750 nm, from 70 nm to 700 nm, from 80 nm to 650 nm, from 90 nm to 600 nm, from 100 nm to 550 nm, or from 150 nm to 500 nm). In some examples, the nanoparticles have a diameter from approximately 100 nm to 1000 nm (e.g., from 100 nm to 200 nm, from 200 nm to 300 nm, from 300 nm to 400 nm, from 400 nm to 500 nm, from 500 nm to 600 nm, from 600 nm to 700 nm, from 700 nm to 800 nm, from 800 nm to 900 nm, or from 900 nm to 1000 nm). In some examples, the nanoparticles have a diameter from approximately 10 nm to 100 nm (e.g., 10 nm to 30 nm, 30 nm to 50 nm, 50 nm to 70 nm, or 70 nm to 100 nm).

In some examples, the plurality of nanoparticles or nanowires includes nanowires having a diameter from approximately 10 nm to 200 nm (e.g., from 15 nm to 180 nm, from 20 nm to 160 nm, from 25 nm to 140 nm, from 30 nm to 120 nm, or from 35 nm to 100 nm). In some examples, the nanowires have a diameter from approximately 10 nm to 100 nm (e.g., 10 nm to 30 nm, 30 nm to 50 nm, 50 nm to 70 nm, or 70 nm to 90 nm). In some examples, the nanowires have a length from approximately 5 μm to 500 μm (e.g., from 10 μm to 400 μm, from 20 μm to 300 μm, from 30 μm to 200 μm, or from 40 μm to 100 μm). In some examples, the nanowires have a length from approximately 100 μm to 500 μm (e.g., 100 μm to 200 μm, 200 μm to 300 um, 300 μm to 400 μm, or 400 μm to 500 μm).

In some examples, the composition as described herein may optionally include one or more solvents. In some examples, the solvent is water, an organic solvent, or mixtures thereof. In some examples, the organic solvent is an alcohol. In some examples, the alcohol is isopropanol (isopropyl alcohol). In some examples, the organic solvent is an ether. In some examples, the organic solvent is tetrahydrofuran. In some examples, the organic solvent is butyl-3-hydroxybutyrate.

### 2. Methods of Wetting Noble Metal Inks to Silicone Substrates

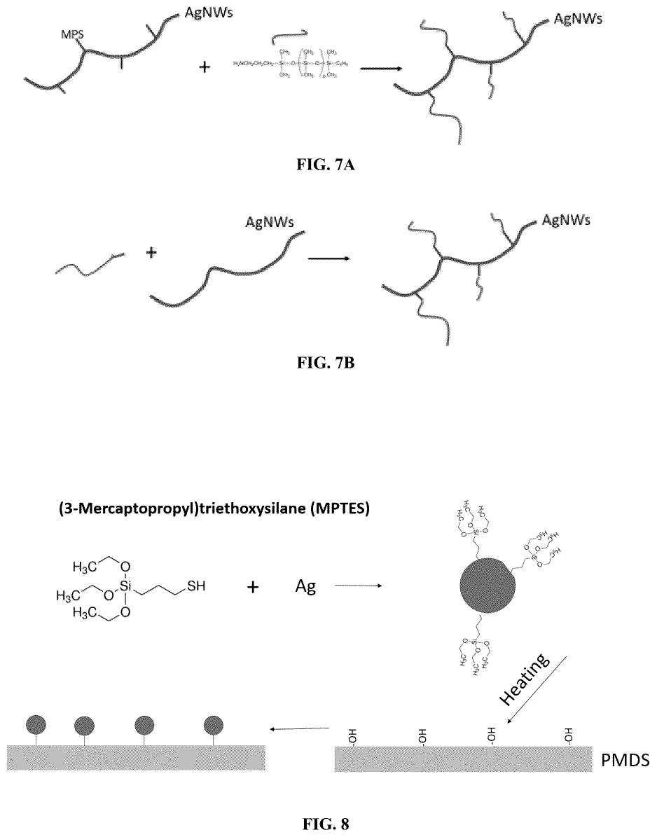

Also provided herein is a method of wetting noble metal inks to silicone substrates. In some examples, the method includes dissolving a small molecule binder that includes a thiol group and a sulfonic acid group in a solvent to make a first solution of small molecule binder; adding to the first solution a plurality of nanoparticles or nanowires including at least one of Ru, Rh, Pd, Ag, Os, Ir, Pt, or Au, to form a second solution; adding to the second solution silicon-based organic polymer, to form a third solution; and applying the third solution to a silicone substrate. In some examples, the method further includes printing the third solution onto the silicone substrate. In some examples, the small molecule binder that includes a thiol group and a sulfonic acid group is prepared from a small molecule binder that includes a thiol group and a sulfonate group, wherein the sulfonate is protonated by adding a protonating reagent to the sulfonate on the small molecule binder. In some examples, the silicon-based organic polymer is amine-terminated. In some examples, the silicon-based organic polymer is imidazole-terminated. In one non-limiting example, FIG. 7A shows a schematic of the method for preparing compositions as described herein for wetting to silicone substrates, where a small molecule binder, such as MPS, is first added to silver nanowires, and then subsequently added to a silicon-based organic polymer.

In other examples, the method includes dissolving a small molecule binder that includes a thiol and a sulfonic acid in water, an organic solvent, or a mixture of water and organic solvent to make a first solution of small molecule binder; adding to the first solution an amine-terminated silicon-based organic polymer, to form a second solution; adding to the second solution a plurality of nanoparticles or nanowires including at least one of Ru, Rh, Pd, Ag, Os, Ir, Pt, or Au, to form a third solution; and applying the third solution to a silicone substrate. In some examples, the method further includes printing the third solution onto the silicone substrate. In some examples, the small molecule binder that includes a thiol group and a sulfonic acid group is prepared from a small molecule binder that includes a thiol group and a sulfonate group, wherein the sulfonate is protonated by adding a protonating reagent to the sulfonate on the small molecule binder. In one non-limiting example, FIG. 7B shows a schematic of the method for preparing compositions as described herein for wetting to silicone substrates, where a small molecule binder, such as MPS, is first added to a silicon-based organic polymer, and then subsequently added to a silver nanowires.

The small molecule binder including a thiol group and a sulfonic acid group refers to an organic compound that includes one or more thiol groups and one or more sulfonic acid groups. In some examples, the small molecule binder including a thiol group and a sulfonic acid group can include 3-mercapto-1-propanesulfonic acid, 2-mercapto-ethanesulfonic acid, 3-(5-mercapto-1-tetrazolyl)benzenesulfonic acid, 5-mercaptoquinoline-8-sulfonic acid, 4-mercaptoquinoline-8-sulfonic acid, 8-mercaptoquinoline-5-sulfonic acid, 4-mercaptoquinoline-3-sulfonic acid, 2-mercapto-5-benzimidazolesulfonic acid, or combinations thereof.

In some examples, the solvent includes water, one or more organic solvents, or a combination thereof. In some examples, the organic solvent is an alcohol. In some examples, the alcohol is isopropanol (isopropyl alcohol). In some examples, the organic solvent is an ether. In some examples, the organic solvent is tetrahydrofuran. In some examples, the organic solvent is butyl-3-hydroxybutyrate.

In some examples, the protonating reagent is an acid. In other examples, the protonating reagent is an ion exchange medium. In some examples, the cation exchange medium includes DOWEX Marathon C Cation exchange resin, commercially available from Sigma Aldrich (St. Louis, Missouri). In some examples, the cation exchange medium is hydrogen form. In some non-limiting examples, the cation exchange medium includes AMBERLITE MB20 H/OH Mixed Bed Ion Exchange resin hydrogen and hydroxide form commercially available from Sigma Aldrich (St. Louis, Missouri), AMBERLITE MAC-3 H Cation Exchange Resin commercially available from Sigma Aldrich (St. Louis, Missouri), AMBERCHROM 50WX2 100-200 Mesh (H+) Cation Exchange Resin commercially available from Sigma Aldrich (St. Louis, Missouri), or DOWEX G26 hydrogen form commercially available from Sigma Aldrich (St. Louis, Missouri).

In some examples, the plurality of nanoparticles or nanowires includes nanoparticles including Ag and/or Au. In some examples, the plurality of nanoparticles or nanowires include nanowires including Ag and/or Au.

In some examples, the plurality of nanoparticles or nanowires includes nanoparticles having a diameter from approximately 10 nm to 1,000 nm (e.g., from 20 nm to 950 nm, from 30 nm to 900 nm, from 40 nm to 850 nm, from 50 nm to 800 nm, from 60 nm to 750 nm, from 70 nm to 700 nm, from 80 nm to 650 nm, from 90 nm to 600 nm, from 100 nm to 550 nm, or from 150 nm to 500 nm). In some examples, the nanoparticles have a diameter from approximately 100 nm to 1000 nm (e.g., from 100 nm to 200 nm, from 200 nm to 300 nm, from 300 nm to 400 nm, from 400 nm to 500 nm, from 500 nm to 600 nm, from 600 nm to 700 nm, from 700 nm to 800 nm, from 800 nm to 900 nm, or from 900 nm to 1000 nm). In some examples, the nanoparticles have a diameter from approximately 10 nm to 100 nm (e.g., 10 nm to 30 nm, 30 nm to 50 nm, 50 nm to 70 nm, or 70 nm to 100 nm).

In some examples, the plurality of nanoparticles or nanowires includes nanowires having a diameter from approximately 10 nm to 200 nm (e.g., from 15 nm to 180 nm, from 20 nm to 160 nm, from 25 nm to 140 nm, from 30 nm to 120 nm, or from 35 nm to 100 nm). In some examples, the nanowires have a diameter from approximately 10 nm to 100 nm (e.g., 10 nm to 30 nm, 30 nm to 50 nm, 50 nm to 70 nm, or 70 nm to 90 nm). In some examples, the nanowires have a length from approximately 5 μm to 500 μm (e.g., from 10 μm to 400 μm, from 20 μm to 300 μm, from 30 μm to 200 μm, or from 40 μm to 100 μm). In some examples, the nanowires have a length from approximately 100 μm to 500 μm (e.g., 100 μm to 200 μm, 200 μm to 300 um, 300 μm to 400 μm, or 400 μm to 500 μm).

In some examples, the silicon-based organic polymer includes a polysiloxane (silicone polymer). In some examples, the silicone polymer is polydimethylsiloxane (PDMS), polymethyl vinyl siloxane, polymethyl hydrogen siloxane, or copolymers or a combination thereof. In some examples, the silicon-based organic polymer is a fluorosilicone. In some examples, the fluorosilicone includes a siloxane backbone and fluorocarbon pendant groups. In some examples, the fluorosilicone is poly (3,3,3-trifluoropropyl methylsiloxane) (PTFPMS). In some examples, the fluorosilicone is SILASTIC (commercially available from Dow, Midland, MI). In some examples, the fluorosilicone is SHIN ETSU FE or SHIN ETSU FEA (commercially available from Shin-Etsu Silicones of America, Inc., Akorn, OH) (e.g., FE-221U, FE-281U, FE-341U, FE-361U, FE-371U, FE-381U, FE-401U, FEA-241U, FEA-251U, FEA-261U, or FEA-271U). In some examples, the silicone-based polymer is a block copolymer containing PDMS and fluorocarbon segments.

In some examples, the silicon-based organic polymer is amine-terminated. In some examples, the silicone polymer is amine-terminated. In some examples, the PDMS, polymethyl vinyl siloxane, or polymethyl hydrogen siloxane is amine-terminated. In some examples, the amine is a primary amine, a secondary amine, a tertiary amine, or a quaternary amine. In some examples, the amine is optionally substituted with alkyl or aryl groups. As used herein, alkyl refers to straight-and branched-chain monovalent substituents. Ranges of these groups useful with the compounds and methods described herein include C₁-C₂₀ alkyl, C₁-C₁₈ alkyl, C₁-C₁₆ alkyl, C₁-C₁₄ alkyl, C₁-C₁₂ alkyl, C₁-C₁₀ alkyl, C₁-C₈ alkyl, C₁-C₆ alkyl, and C₁-C₄ alkyl. Examples include methyl, ethyl, propyl, butyl, isobutyl, octyl, and the like. Aryl molecules include, for example, cyclic hydrocarbons that incorporate one or more planar sets of, typically, six carbon atoms that are connected by delocalized electrons numbering the same as if they consisted of alternating single and double covalent bonds. An example of an aryl molecule is benzene (i.e., a phenyl group). In some examples, the amine is —NRR′, wherein R and R′ are independently selected from hydrogen, halogen, hydroxyl, alkyl, haloalkyl, aryl, and heteroaryl. In some examples, the amine is —NRR′, wherein R and R′ are independently selected from hydrogen, halogen, hydroxyl, alkyl, haloalkyl, aryl, and heteroaryl. In some examples, the amine is a substituted or unsubstituted cyclic amine, such as a pyrrolidine, where the pyrrolidine may be optionally substituted with alkyl or aryl groups. In some examples, the amine is a protonated ammonium —(NRR′H)⁺, wherein R and R′ are independently selected from hydrogen, halogen, hydroxyl, alkyl, haloalkyl, aryl, and heteroaryl. In some examples, the amine-terminated PDMS is a mono-amino terminated PDMS, including but not limited to, monoaminopropyl terminated polydimethylsiloxane, asymmetric, 18-25 cSt (MCR-A12), or monoaminopropyl terminated polydimethylsiloxane, asymmetric, 8-12 cSt (MCR-A11), commercially available from Gelest, Inc. (Morrisville, Pennsylvania). In some examples, the silicon-based organic polymer is terminated with an imidazole group, where the imidazole group may be optionally substituted with alkyl or aryl groups.

In some examples, applying the third solution to the silicone substrate includes spin coating, blade coating, and/or ink jet printing the third solution onto the silicone substrate.

In some examples, the silicone substrate is a silicone elastomer. In some examples, the silicone substrate is a silicone rubber, such as ELASTOSIL, commercially available from Wacker Chemie AG (Munich, Germany); a silicone elastomer, such as SYLGARD 184, commercially available from Dow Chemical Co. (Midland, Michigan); a silicone rubber, such as ECOFLEX, commercially available from Smooth-On, Inc. (Macungie, Pennsylvania); a silicone rubber, such as DRAGONSKIN, commercially available from Sooth-On, Inc. (Macungie, Pennsylvania); or a silicone, such as BLUESIL, commercially available from Elkem (Oslo, Norway).

### 3. Compositions for Adhesion of Noble Metal Inks to Silicone Substrates

Also provided herein is a composition including a small molecule binder including a thiol group and a silane group, a silicon-based organic polymer, and a plurality of nanoparticles or nanowires including at least one of Ru, Rh, Pd, Ag, Os, Ir, Pt, or Au. Optionally, the composition further includes a small molecule binder comprising a thiol group and a sulfonic acid group as described herein. FIG. 8 shows one non-limiting schematic example of the composition including a small molecule binder comprising a thiol group and a silane group, a silicon-based organic polymer, and a plurality of nanoparticles or nanowires comprising Ag.

The small molecule binder including a thiol group and a silane group refers to an organic compound that includes one or more thiol groups and one or more silane groups. In some examples, the small molecule binder including a thiol group and a silane group includes 3-mercaptopropyl triethoxysilane (MPTES), 3-mercaptopropyl trimethoxysilane (MPTMS), mercaptopropyl trihydroxysilane, or a combination thereof.

In some examples, the silicon-based organic polymer includes a polysiloxane (silicone polymer). In some examples, the silicone polymer is polydimethylsiloxane (PDMS), polymethyl vinyl siloxane, polymethyl hydrogen siloxane, or copolymers or a combination thereof. In some examples, the silicon-based organic polymer is a fluorosilicone. In some examples, the fluorosilicone includes a siloxane backbone and fluorocarbon pendant groups. In some examples, the fluorosilicone is poly (3,3,3-trifluoropropyl methylsiloxane) (PTFPMS). In some examples, the fluorosilicone is SILASTIC (commercially available from Dow, Midland, MI). In some examples, the fluorosilicone is SHIN ETSU FE or SHIN ETSU FEA (commercially available from Shin-Etsu Silicones of America, Inc., Akorn, OH) (e.g., FE-221U, FE-281U, FE-341U, FE-361 U, FE-371U, FE-381U, FE-401U, FEA-241U, FEA-251U, FEA-261U, or FEA-271U). In some examples, the silicone-based polymer is a block copolymer containing PDMS and fluorocarbon segments.

In some examples, the silicon-based organic polymer is amine-terminated. In some examples, the silicone polymer is amine-terminated. In some examples, the PDMS, polymethyl vinyl siloxane, or polymethyl hydrogen siloxane is amine-terminated. In some examples, the amine is a primary amine, a secondary amine, a tertiary amine, or a quaternary amine. In some examples, the amine is optionally substituted with alkyl or aryl groups. As used herein, alkyl refers to straight-and branched-chain monovalent substituents. Ranges of these groups useful with the compounds and methods described herein include C₁-C₂₀ alkyl, C₁-C₁₈ alkyl, C₁-C₁₆ alkyl, C₁-C₁₄ alkyl, C₁-C₁₂ alkyl, C₁-C₁₀ alkyl, C₁-C₈ alkyl, C₁-C₆ alkyl, and C₁-C₄ alkyl. Examples include methyl, ethyl, propyl, butyl, isobutyl, octyl, and the like. Aryl molecules include, for example, cyclic hydrocarbons that incorporate one or more planar sets of, typically, six carbon atoms that are connected by delocalized electrons numbering the same as if they consisted of alternating single and double covalent bonds. An example of an aryl molecule is benzene (i.e., a phenyl group). In some examples, the amine is —NRR′, wherein R and R′ are independently selected from hydrogen, halogen, hydroxyl, alkyl, haloalkyl, aryl, and heteroaryl. In some examples, the amine is —NRR', wherein R and R′ are independently selected from hydrogen, halogen, hydroxyl, alkyl, haloalkyl, aryl, and heteroaryl. In some examples, the amine is a substituted or unsubstituted cyclic amine, such as a pyrrolidine, where the pyrrolidine may be optionally substituted with alkyl or aryl groups. In some examples, the amine is a protonated ammonium —(NRR′H)⁺, wherein R and R′ are independently selected from hydrogen, halogen, hydroxyl, alkyl, haloalkyl, aryl, and heteroaryl. In some examples, the amine-terminated PDMS is a mono-amino terminated PDMS, including but not limited to, monoaminopropyl terminated polydimethylsiloxane, asymmetric, 18-25 cSt (MCR-A12), or monoaminopropyl terminated polydimethylsiloxane, asymmetric, 8-12 cSt (MCR-A11), commercially available from Gelest, Inc. (Morrisville, Pennsylvania). In some examples, the silicon-based organic polymer is terminated with an imidazole group, where the imidazole group may be optionally substituted with alkyl or aryl groups.

In some examples, the silicon-based organic polymer has an M_{w} (weighted average molecular weight) from 700 to 3000 Da (Daltons), (e.g., from 750 to 2900 Da, from 800 to 2800 Da, from 850 to 2700 Da, from 900 to 2600 Da, from 950 to 2500 Da, from 1000 to 2400 Da, from 1100 to 2300 Da, from 1200 to 2200 Da, from 1300 to 2100 Da, from 1400 to 2000 Da, from 1500 to 1900 Da, or from 1600 to 1800 Da). In some examples the silicon-based organic polymer has an M_{w} from 3000 Da to 100,000 Da (e.g., from 3000 Da to 90,000 Da, from 6000 Da to 80,000 Da, from 12,000 Da to 70,000 Da, from 18,000 Da to 60,000 Da, or from 24,000 Da to 50,000 Da).

In some examples, the plurality of nanoparticles or nanowires includes Ag. In some examples, the plurality of nanoparticles or nanowires includes Au. In some examples the composition includes nanoparticles comprising Ag and/or Au. In some examples, the composition includes nanowires comprising Ag and/or Au.

In some examples, the plurality of nanoparticles or nanowires includes nanoparticles having a diameter from approximately 10 nm to 1000 nm (e.g., from 20 nm to 950 nm, from 30 nm to 900 nm, from 40 nm to 850 nm, from 50 nm to 800 nm, from 60 nm to 750 nm, from 70 nm to 700 nm, from 80 nm to 650 nm, from 90 nm to 600 nm, from 100 nm to 550 nm, or from 150 nm to 500 nm). In some examples, the nanoparticles have a diameter from approximately 100 nm to 1000 nm (e.g., from 100 nm to 200 nm, from 200 nm to 300 nm, from 300 nm to 400 nm, from 400 nm to 500 nm, from 500 nm to 600 nm, from 600 nm to 700 nm, from 700 nm to 800 nm, from 800 nm to 900 nm, or from 900 nm to 1000 nm). In some examples, the nanoparticles have a diameter from approximately 10 nm to 100 nm (e.g., 10 nm to 30 nm, 30 nm to 50 nm, 50 nm to 70 nm, or 70 nm to 100 nm).

In some examples, the plurality of nanoparticles or nanowires includes nanowires having a diameter from approximately 10 nm to 200 nm (e.g., from 15 nm to 180 nm, from 20 nm to 160 nm, from 25 nm to 140 nm, from 30 nm to 120 nm, or from 35 nm to 100 nm). In some examples, the nanowires have a diameter from approximately 10 nm to 100 nm (e.g., 10 nm to 30 nm, 30 nm to 50 nm, 50 nm to 70 nm, or 70 nm to 90 nm). In some examples, the nanowires have a length from approximately 5 μm to 500 μm (e.g., from 10 μm to 400 μm, from 20 μm to 300 μm, from 30 μm to 200 μm, or from 40 μm to 100 μm). In some examples, the nanowires have a length from approximately 100 μm to 500 μm (e.g., 100 μm to 200 μm, 200 μm to 300 um, 300 μm to 400 μm, or 400 μm to 500 μm).

In some examples, the composition as described herein may optionally include one or more solvents. In some examples, the solvent is water, an organic solvent, or mixtures thereof. In some examples, the organic solvent is an alcohol. In some examples, the alcohol is isopropanol (isopropyl alcohol). In some examples, the organic solvent is an ether. In some examples, the organic solvent is tetrahydrofuran. In some examples, the organic solvent is butyl-3-hydroxybutyrate.

### 4. Methods of Adhering Noble Metal Inks to Silicone Substrates

Also provided herein is a method for adhering noble metal inks to silicone substrates, the method including mixing a small molecule binder comprising a thiol group and a silane group with a plurality of nanoparticles or nanowires comprising at least one of Ru, Rh, Pd, Ag, Os, Ir, Pt, or Au, to form a mixture of the small molecule binder and plurality of nanoparticles or nanowires, and applying the mixture to a silicone substrate, wherein the silicone substrate includes a silicon-based organic polymer. Optionally, the applying step includes printing the mixture onto the silicon substrate. Optionally, the method further includes adding a small molecule binder comprising a thiol group and a sulfonate group to the mixture, prior to applying the mixture to the silicone substrate. Optionally, the mixture includes one or more solvents. In some examples, the solvent is water, an organic solvent, or a combination thereof. In some examples, the solvent is water, isopropyl alcohol, tetrahydrofuran, or a combination thereof. In some examples, the organic solvent is butyl-3-hydroxybutyrate.

Also provided herein is a method for adhering noble metal inks to silicone substrates, the method including adding a small molecule binder comprising a thiol group and a silane group to a plurality of nanoparticles or nanowires comprising at least one of Ru, Rh, Pd, Ag, Os, Ir, Pt, or Au, to form a first mixture of the small molecule binder and plurality of nanoparticles or nanowires, adding to the first mixture a silicon-based organic polymer to form a second mixture, and applying the second mixture to a silicone substrate. Optionally, the method further includes printing the second mixture onto a silicone substrate. Optionally, the method further includes adding a small molecule binder comprising a thiol group and a sulfonate group to the first mixture or to the second mixture, prior to applying the second mixture to the silicone substrate. Optionally, the first mixture and/or the second mixture includes one or more solvents. In some examples, the solvent is water, an organic solvent, or a combination thereof. In some examples, the solvent is water, isopropyl alcohol, tetrahydrofuran, or a combination thereof. In some examples, the organic solvent is butyl-3-hydroxybutyrate.

The small molecule binder comprising a thiol group and a silane group refers to an organic compound that includes one or more thiol groups and one or more silane groups. In some examples, the small molecule binder comprising a thiol group and a silane group includes 3-mercaptopropyl triethoxysilane (MPTES), 3-mercaptopropyl trimethoxysilane (MPTMS), mercaptopropyl trihydroxysilane, or a combination thereof.

In some examples, the silicon-based organic polymer includes a polysiloxane (silicone polymer). In some examples, the silicone polymer is polydimethylsiloxane (PDMS), polymethyl vinyl siloxane, polymethyl hydrogen siloxane, or copolymers or a combination thereof. In some examples, the silicon-based organic polymer is a fluorosilicone. In some examples, the fluorosilicone includes a siloxane backbone and fluorocarbon pendant groups. In some examples, the fluorosilicone is poly (3,3,3-trifluoropropyl methylsiloxane) (PTFPMS). In some examples, the fluorosilicone is SILASTIC (commercially available from Dow, Midland, MI). In some examples, the fluorosilicone is SHIN ETSU FE or SHIN ETSU FEA (commercially available from Shin-Etsu Silicones of America, Inc., Akorn, OH) (e.g., FE-221U, FE-281U, FE-341U, FE-361U, FE-371U, FE-381U, FE-401U, FEA-241U, FEA-251U, FEA-261U, or FEA-271U). In some examples, the silicone-based polymer is a block copolymer containing PDMS and fluorocarbon segments.

In some examples, the silicon-based organic polymer is amine-terminated. In some examples, the silicone polymer is amine-terminated. In some examples, the PDMS, polymethyl vinyl siloxane, or polymethyl hydrogen siloxane is amine-terminated. In some examples, the amine is a primary amine, a secondary amine, a tertiary amine, or a quaternary amine. In some examples, the amine is optionally substituted with alkyl or aryl groups. As used herein, alkyl refers to straight-and branched-chain monovalent substituents. Ranges of these groups useful with the compounds and methods described herein include C₁-C₂₀ alkyl, C₁-C₁₈ alkyl, C₁-C₁₆ alkyl, C₁-C₁₄ alkyl, C₁-C₁₂ alkyl, C₁-C₁₀ alkyl, C₁-C₈ alkyl, C₁-C₆ alkyl, and C₁-C₄ alkyl. Examples include methyl, ethyl, propyl, butyl, isobutyl, octyl, and the like. Aryl molecules include, for example, cyclic hydrocarbons that incorporate one or more planar sets of, typically, six carbon atoms that are connected by delocalized electrons numbering the same as if they consisted of alternating single and double covalent bonds. An example of an aryl molecule is benzene (i.e., a phenyl group). In some examples, the amine is-NRR', wherein R and R′ are independently selected from hydrogen, halogen, hydroxyl, alkyl, haloalkyl, aryl, and heteroaryl. In some examples, the amine is —NRR′, wherein R and R′ are independently selected from hydrogen, halogen, hydroxyl, alkyl, haloalkyl, aryl, and heteroaryl. In some examples, the amine is a substituted or unsubstituted cyclic amine, such as a pyrrolidine, where the pyrrolidine may be optionally substituted with alkyl or aryl groups. In some examples, the amine is a protonated ammonium —(NRR′H)⁺, wherein R and R′ are independently selected from hydrogen, halogen, hydroxyl, alkyl, haloalkyl, aryl, and heteroaryl. In some examples, the amine-terminated PDMS is a mono-amino terminated PDMS, including but not limited to, monoaminopropyl terminated polydimethylsiloxane, asymmetric, 18-25 cSt (MCR-A12), or monoaminopropyl terminated polydimethylsiloxane, asymmetric, 8-12 cSt (MCR-A11), commercially available from Gelest, Inc. (Morrisville, Pennsylvania). In some examples, the silicon-based organic polymer is terminated with an imidazole group, where the imidazole group may be optionally substituted with alkyl or aryl groups.

In some examples, the silicon-based organic polymer has an M_{w} (weighted average molecular weight) from 700 to 3000 Da (Daltons), (e.g., from 750 to 2900 Da, from 800 to 2800 Da, from 850 to 2700 Da, from 900 to 2600 Da, from 950 to 2500 Da, from 1000 to 2400 Da, from 1100 to 2300 Da, from 1200 to 2200 Da, from 1300 to 2100 Da, from 1400 to 2000 Da, from 1500 to 1900 Da, or from 1600 to 1800 Da). In some examples the silicon-based organic polymer has an M_{w} from 3000 Da to 100,000 Da (e.g., from 3000 Da to 90,000 Da, from 6000 Da to 80,000 Da, from 12,000 Da to 70,000 Da, from 18,000 Da to 60,000 Da, or from 24,000 Da to 50,000 Da).

In some examples, the plurality of nanoparticles or nanowires includes Ag. In some examples, the plurality of nanoparticles or nanowires includes Au. In some examples the composition includes nanoparticles comprising Ag and/or Au. In some examples, the composition includes nanowires comprising Ag and/or Au.

In some examples, the plurality of nanoparticles or nanowires includes nanoparticles having a diameter from approximately 10 nm to 1,000 nm (e.g., from 20 nm to 950 nm, from 30 nm to 900 nm, from 40 nm to 850 nm, from 50 nm to 800 nm, from 60 nm to 750 nm, from 70 nm to 700 nm, from 80 nm to 650 nm, from 90 nm to 600 nm, from 100 nm to 550 nm, or from 150 nm to 500 nm). In some examples, the nanoparticles have a diameter from approximately 100 nm to 1000 nm (e.g., from 100 nm to 200 nm, from 200 nm to 300 nm, from 300 nm to 400 nm, from 400 nm to 500 nm, from 500 nm to 600 nm, from 600 nm to 700 nm, from 700 nm to 800 nm, from 800 nm to 900 nm, or from 900 nm to 1000 nm). In some examples, the nanoparticles have a diameter from approximately 10 nm to 100 nm (e.g., 10 nm to 30 nm, 30 nm to 50 nm, 50 nm to 70 nm, or 70 nm to 100 nm).

In some examples, the plurality of nanoparticles or nanowires includes nanowires having a diameter from approximately 10 nm to 200 nm (e.g., from 15 nm to 180 nm, from 20 nm to 160 nm, from 25 nm to 140 nm, from 30 nm to 120 nm, or from 35 nm to 100 nm). In some examples, the nanowires have a diameter from approximately 10 nm to 100 nm (e.g., 10 nm to 30 nm, 30 nm to 50 nm, 50 nm to 70 nm, or 70 nm to 90 nm). In some examples, the nanowires have a length from approximately 5 μm to 500 μm (e.g., from 10 μm to 400 μm, from 20 μm to 300 μm, from 30 μm to 200 μm, or from 40 μm to 100 μm). In some examples, the nanowires have a length from approximately 100 μm to 500 μm (e.g., 100 μm to 200 μm, 200 μm to 300 um, 300 μm to 400 μm, or 400 μm to 500 μm).

In some examples, the silicone substrate is a silicone elastomer. In some examples, the silicone substrate is a silicone rubber, such as ELASTOSIL, commercially available from Wacker Chemie AG (Munich, Germany); a silicone elastomer, such as SYLGARD 184, commercially available from Dow Chemical Co. (Midland, Michigan); a silicone rubber, such as ECOFLEX, commercially available from Smooth-On, Inc. (Macungie, Pennsylvania); a silicone rubber, such as DRAGONSKIN, commercially available from Sooth-On, Inc. (Macungie, Pennsylvania); or a silicone, such as BLUESIL, commercially available from Elkem (Oslo, Norway).

### 5. Uses of Noble Metal Ink Compositions and Methods of Wetting and Adhering

Also provided herein is a use of any one of the compositions described herein for printing on a substrate. In some examples, the printing is screen printing or ink jet printing. In some examples, the substrate is glass and/or polymer. In some examples, the polymer substrate is a silicone substrate. In some examples, the use of any one of the compositions described herein is for conductive ink applications, such as, but not limited to, touchscreen fabrication, photovoltaics, automotive manufacture, medical devices, radio frequency identifications (RFIDs), sensors (including biopotential sensors), augmented reality or virtual reality (AR/VR) applications, or batteries.

Also provided herein is a use of any one of the methods of wetting noble metal inks described herein for printing the noble metal inks on a substrate. In some examples, the printing is screen printing or ink jet printing. In some examples, the substrate is glass and/or a polymer. In some examples, the polymer substrate is a silicone substrate. In some examples, the use of any one of the methods of wetting noble metal inks described herein is for conductive ink applications, such as, but not limited to, touchscreen fabrication, photovoltaics, automotive manufacture, medical devices, radio frequency identifications (RFIDs), sensors (including biopotential sensors), or batteries.

Also provided herein is a use of any one of the methods of adhering noble metal inks described herein for printing the noble metal inks on a substrate. In some examples, the printing is screen printing or ink jet printing. In some examples, the substrate is glass and/or polymer. In some examples, the polymer substrate is a silicone substrate. In some examples, the use of any one of the methods of adhering noble metal inks described herein is for conductive ink applications, such as, but not limited to, touchscreen fabrication, photovoltaics, automotive manufacture, medical devices, radio frequency identifications (RFIDs), sensors (including biopotential sensors), or batteries.

Throughout this application, various publications are referenced. The disclosures of these publications in their entireties are hereby incorporated by reference into this application.

The examples below are intended to further illustrate certain aspects of the methods and compositions described herein, and are not intended to limit the scope of the claims.

### EXAMPLES

### Example 1: Wetting of Silver Nanowires (“AgNWs”) Ink to Silicone Substrate

A solution of AgNWs (25-35 nm in diameter and 15-25 μm in length), 1 wt. % in isopropanol (“IPA”) was prepared, (Stock #0475NW3I) commercially available from Nanostructured & Amorphous Materials, Inc. (“NanoAmor”) (Katy, Texas).

A solution of sodium-3-mercapto-1-propanesulfonate (“MPS”), commercially available from Sigma Aldrich (St. Louis, Missouri), in water (0.4 mol/L (M)) was prepared.

For each 20 mL of the stock solution of sodium-3-mercapto-1-propanesulfonate was added 0.2 grams (g) ion exchange medium Dowex Marathon C Cation exchange resin, commercially available from Sigma Aldrich (St. Louis, Missouri), to protonate the sodium-3-mercapto-1-propanesulfonate and form 3-mercapto-1-propanesulfonic acid. The pH of the solution was observed to drop by 2-3 pH units upon addition of the cation exchange medium. MCR-A12, a mono-amino terminated PDMS (M_{w}˜2000 Da), commercially available from Gelest, Inc. (Morrisville, Pennsylvania), was added to the solution of 3-mercapto-1-propanesulfonic acid until the pH of the solution was neutral. This step couples the 3-mercapto-1-propanesulfonic acid with MCR-A12 to form a small molecule binder as described herein.

To the solution of AgNWs in isopropanol was added the solution of 3-mercapto-1-propanesulfonic acid and MCR-A12 small molecule binder until the concentration of the 3-mercapto-1-propanesulfonic acid and MCR-A12 small molecule binder was approximately 0.2 mmol/L (0.2 mM). The solution of AgNWs and small molecule binder was stirred at room temperature for approximately ten hours.

The resulting reaction mixture was printed into silicone substrates as described herein.

If no agglomeration is observed in solution of AgNWs following the addition of small molecule binder, additional small molecule binder is added to the solution.

Control compositions containing only AgNWs (25-35 nm in diameter and 15-25 μm in length), 1 wt. % in isopropanol (“IPA”) were prepared, (Stock #0475NW3I) commercially available from Nanostructured & Amorphous Materials, Inc. (“NanoAmor”) (Katy, Texas). The control compositions were printed into silicone substrates as described herein.

FIG. 2 shows a non-limiting example of the wetting properties of a composition as described above on an ELASTOSIL silicone substrate in the left panel of FIG. 2, where the composition shown in the left panel contains AgNWs that are modified with PDMS and the small molecule binder comprising the sulfonic acid and thiol as described above. The right panel of FIG. 2 shows the wetting properties of a control composition on an ELASTOSIL silicone substrate that does not include the small molecule binder. Both samples shown in the left and right panels were stretched to 20% strain for 100 cycles. Without being limited by theory, improved wetting of the composition as described herein, and shown in the left panel, contributed to improved wetting on silicone relative to the control sample shown on the right, thereby contributing to better settling on the substrate shown on the right, and enhanced performance in the electromechanical test, as shown in FIG. 2.

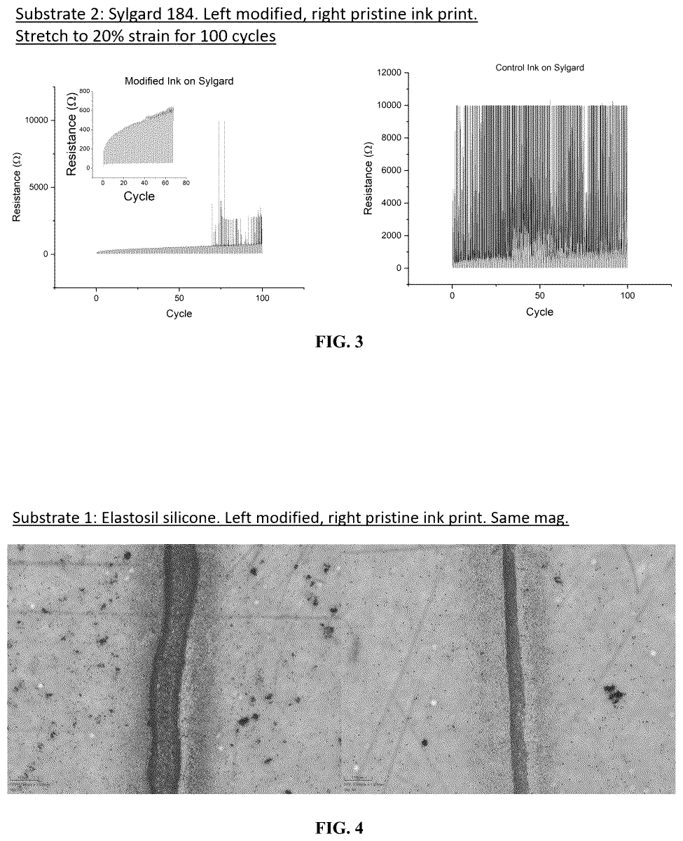

FIG. 3 shows a non-limiting example of the wetting properties of a composition as described above on a SYLGARD 184 silicone substrate in the left panel of FIG. 3. The right panel of FIG. 3 shows the wetting properties of a control composition on a SYLGARD 184 silicone substrate that does not comprise the small molecule binder comprising a thiol and a sulfonic acid as described herein. Both samples shown in the left and right panels were stretched to 20% strain for 100 cycles.

FIG. 4 shows microscopic images of ELASTOSIL silicone substrates printed with compositions as described above (left) and control compositions as described above that lack the small molecule binders including a thiol and a sulfonic acid (right). The wider trace shown on the left indicates improved wetting properties of the compositions described herein compared to the control composition on the right. Compared to the control sample on the right, the sample on the left shows improved wetting, correlating the to the wider ink traces seen for the sample on the left relative to the control sample on the right.

FIG. 5 shows microscopic images of SYLGARD 184 silicone substrates printed with compositions as described above (left) and control compositions as described above that lack the small molecule binders comprising a thiol and a sulfonic acid (right). The wider trace shown on the left indicates improved wetting properties of the compositions described herein compared to the control composition on the right.

### Example 2: Adhesion and Wetting of Printed AgNWs on Silicone Substrate

Adhesion properties were also achieved by adding an additional small molecule binder comprising a thiol and a silane, such as 3-mercaptopropyl triethoxysilane (MPTES), to the solution of AgNWs (approximately 1 wt. % AgNWs in isopropanol), 3-mercapto-1-propanesulfonic acid and MCR-A12, such that the concentration of MPTES was between 0.15 mM and 0.20 mM.

The resulting reaction mixture was printed onto silicone substrates as described herein. To promote adhesion and bonding following the printing step, the silicone substrates were thermally treated in an isothermal oven for 15-60 minutes at 120-150° C.

Control compositions containing only AgNWs (approximately 1 wt. % AgNWs in isopropanol) without the small molecule binder were also prepared.

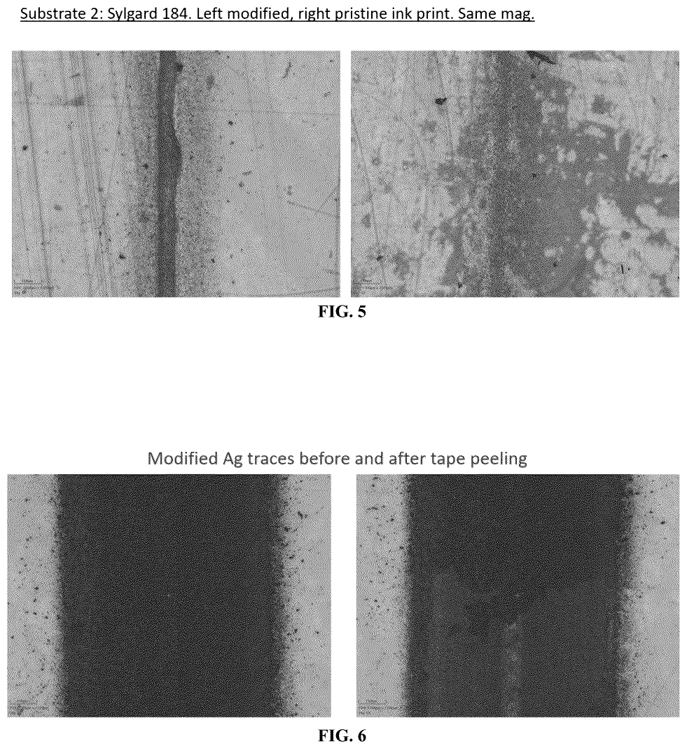

FIG. 6 shows a nonlimiting example of the adhesion properties after a tape peel test of compositions described above to silicone substrates, where minimal loss of compositions comprising AgNWs modified with the small molecule binder comprising the thiol and silane, as described above, was observed. In contrast, a separate tape peel test of control compositions of AgNWs lacking the small molecule binder showed that those compositions were completely peeled off following the tape peel.

The compositions and methods of the appended claims are not limited in scope by the specific compositions and methods described herein, which are intended as illustrations of a few aspects of the claims and any compositions and methods that are functionally equivalent are within the scope of this disclosure. Various modifications of the compositions and methods in addition to those shown and described herein are intended to fall within the scope of the appended claims. Further, while only certain representative compositions, methods, and aspects of these compositions and methods are specifically described, other compositions and methods are intended to fall within the scope of the appended claims. Thus, a combination of steps, elements, components, or constituents can be explicitly mentioned herein; however, all other combinations of steps, elements, components, and constituents are included, even though not explicitly stated.

What is claimed is:

1. A composition comprising:
a small molecule binder comprising a thiol group and a sulfonic acid group,
a silicon-based organic polymer, and
a plurality of nanoparticles or nanowires comprising at least one of Ru, Rh, Pd, Ag, Os, Ir, Pt, or Au.

2. The composition of claim 1, wherein the small molecule binder is 3-mercapto-1-propanesulfonic acid, 2-mercapto-ethanesulfonic acid, or 3-(5-mercapto-1-tetrazolyl)benzenesulfonic acid.

3. The composition of claim 1, wherein the silicon-based organic polymer is a polydimethylsiloxane (PDMS).

4. The composition of claim 3, wherein the PDMS is terminated by an amine.

5. The composition of claim 4, wherein the amine is a primary amine or a secondary amine.

6. The composition of claim 1, wherein the silicon-based organic polymer has an M_{w} between 700 and 3000 Da.

7. The composition of claim 1, wherein the plurality of nanoparticles or nanowires comprises Ag or Au.

8. A method of wetting of noble metal inks on silicone substrates, the method comprising:
dissolving a small molecule binder that comprises a thiol and a sulfonic acid in a solvent to make a first solution of small molecule binder;
adding to the first solution a plurality of nanoparticles or nanowires comprising at least one of Ru, Rh, Pd, Ag, Os, Ir, Pt, or Au, to form a second solution;
adding to the second solution an amine-terminated silicon-based organic polymer, to form a third solution; and
applying the third solution to a silicone substrate.

9. The method of claim 8, further comprising printing the third solution onto the silicone substrate.

10. The method of claim 8, wherein the small molecule binder is selected from the group consisting of 3-mercapto-1-propanesulfonic acid, 2-mercapto-ethansulfonic acid, and 3-(5-mercapto-1-tetrazolyl)benzenesulfonic acid.

11. The method of claim 8, wherein the solvent is water, an organic solvent, or a mixture thereof.

12. The method of claim 8, wherein the plurality of nanoparticles or nanowires comprises Ag or Au.

13. The method of claim 8, wherein the amine-terminated silicon-based organic polymer has an M_{w} between 700 and 3000 Da.

14. The method of claim 8, wherein the amine-terminated silicon-based organic polymer comprises a mono-amino-terminated PDMS.

15. The method of claim 14, wherein the mono-amino-terminated PDMS is mono-aminopropyl terminated polydimethylsiloxane, asymmetric, 18-25 cSt (MCR-A12) or mono-aminopropyl terminated polydimethylsiloxane, asymmetric, 8-12 cSt (MCR-A11).

16. A method of wetting of noble metal inks on silicone substrates, the method comprising:
dissolving a small molecule binder that comprises a thiol and a sulfonic acid in water, an organic solvent, or a mixture of water and organic solvent to make a first solution of small molecule binder;
adding to the first solution an amine-terminated silicon-based organic polymer, to form a second solution;
adding to the second solution a plurality of nanoparticles or nanowires comprising at least one of Ru, Rh, Pd, Ag, Os, Ir, Pt, or Au, to form a third solution; and
applying the third solution to a silicone substrate.

17. The method of claim 16, further comprising printing the third solution onto the silicone substrate.

18. The method of claim 16, wherein the small molecule binder is selected from the group consisting of 3-mercapto-1-propanesulfonic acid, 2-mercapto-ethansulfonic acid, and 3-(5-mercapto-1-tetrazolyl)benzenesulfonic acid.

19. The method of claim 16, wherein the plurality of nanoparticles or nanowires comprise Ag or Au.

20. The method of claim 16, wherein the amine-terminated silicon-based organic polymer has an M_{w} between 700 and 3000 Da.

21. The method of claim 16, wherein the amine-terminated silicon-based organic polymer comprises a mono-amino-terminated PDMS.

22. The method of claim 21, wherein the mono-amino-terminated PDMS is monoAminopropyl terminated polydimethylsiloxane, asymmetric, 18-25 cSt (MCR-A12) or monoAminopropyl terminated polydimethylsiloxane, asymmetric, 8-12 cSt (MCR-A11).

23. A composition comprising:
a small molecule binder comprising a thiol group and a silane group,
a silicon-based organic polymer, and
a plurality of nanoparticles or nanowires comprising at least one of Ru, Rh, Pd, Ag, Os, Ir, Pt, or Au.

24. A method for adhering noble metal inks to silicone substrates, the method comprising:
mixing a small molecule binder comprising a thiol and a silane with a plurality of nanoparticles or nanowires comprising at least one of Ru, Rh, Pd, Ag, Os, Ir, Pt, or Au, to form a mixture of the small molecule binder and plurality of nanoparticles or nanowires; and
applying the mixture of the small molecule binder and plurality of nanoparticles or nanowires to a silicone substrate, wherein the silicone substrate comprises a silicon-based organic polymer.

25. The method of claim 24, wherein the small molecule binder is 3-mercaptopropyl triethoxysilane (MPTES).

26. The method of claim 24, wherein the silicon-based organic polymer is an amine-terminated silicon-based organic polymer.

27. The method of claim 24, wherein the silicon-based organic polymer is mono-aminopropyl terminated polydimethylsiloxane, asymmetric, 18-25 cSt (MCR-A12) or mono-aminopropyl terminated polydimethylsiloxane, asymmetric, 8-12 cSt (MCR-A11).
